(19) United States
(12) Patent Application Publication
(10) Pub. No.: US 2013/0011489 A1
(43) Pub. Date: Jan. 10, 2013

(54) ANTI-FUNGAL COMPOSITIONS AND ASSOCIATED METHODS

(76) Inventor: Steven R. Teerlink, Sandy, UT (US)

(21) Appl. No.: 13/541,991

(22) Filed: Jul. 5, 2012

Related U.S. Application Data
(60) Provisional application No. 61/504,410, filed on Jul. 5, 2011.

(51) Int. Cl. A01N 59/26; A01C 23/00; A01P 3/00

(52) U.S. Cl. 424/604; 424/601; 111/118

(57) ABSTRACT

The present disclosure provides methods and compositions for treating fungal diseases of plants. In one embodiment, an anti-fungal aqueous composition can comprise: a nitrogen source material having a total nitrogen content in an amount of about 0.1 wt % to about 0.5 wt % of the total weight of the composition, a phosphate source material having total phosphate content in an amount of about 0.05 wt % to about 0.15 wt % of the total weight of the composition, a potassium source material with a soluble potash content in an amount of about 0.05 wt % to about 0.15 wt % of the total weight of the composition, and a sulfur source material in an amount of about 0.005 wt % to about 0.02 wt % of the total weight of the composition.

### PRIORITY CLAIM

This application claims the benefit of U.S. Provisional Patent Application Ser. No. 61/504,410 filed on Jul. 5, 2011, which is hereby incorporated by reference in its entirety.

### BACKGROUND

In the field of agriculture and horticulture, it is well known to control plant pests such as harmful insects, fungi, and microorganisms, such as bacteria and viruses. Such controls can include sprays carrying traditional synthetic chemical pesticides. Additionally, certain sprays can be used without chemical pesticides, in which case the oil component of the spray can be used to coat the pests to induce a potential variety of effects, including suffocation of insects, modification of insect feeding and egg laying behavior, destruction of fungi cell walls, removal of humidity, and interference with physical interactions of fungi or viruses with the host plant. For some applications, it can be desired to use sprays without added chemical pesticides. Such sprays are generally considered to be safer for humans, are less harmful to beneficial insects such as bees, and are more quickly degraded. In addition, the cost of effort of manufacturing chemical pesticides is avoided, while sprays can be simply made out of inexpensive fractions of petroleum oil. The main limitation of such sprays is their potential to cause plant injury (phytotoxicity) in some situations, as with certain sensitive plants or plants under drought stress. A particularly desirous use of sprays is in the control of turfgrass pests. Turfgrass generally includes any maintained grass surface, such as are typically used for lawns at homes, businesses, parks, golf courses, etc. Turfgrass has been traditionally treated with synthetic chemical compounds to control pests, resulting is high maintenance costs and harmful effects to humans and the environment.

In addition to such pests, soil contains a diversity of life forms which can interact with plants, including bacteria, fungi, and nematodes. These biological forms are particularly abundant in the rhizosphere, the area of soil that surrounds and is influenced by the plant roots. Rhizobacteria are those bacteria which are adapted to the rhizosphere. There is a complex interaction among the various life forms in the soil, where some are antagonistic and others are mutually beneficial. Similarly complex is the interaction between the plants and the soil life forms, which can helpful to the plant in some instances, and harmful in others. Nematode pathogens harmful to plants include species from the genera Meloidogyne, Heterodera, Ditylenchus, and Pratylenchus. Nematode-caused plant diseases include root galls, root rot, lesions, “stubby root,” stunting, as well as other rots and wilts resulting from pathogenic fungi effects on nematode-weakened plants. Fungal species that are harmful to plants come from a wide variety of genera, including Fusarium, Pythium, Phytophthora, Verticillium, Rhizoctonia, Macrophomina, Thielaviopsis and Scierotinas. Plant diseases caused by fungi include pre- and post-emergence seedling damping-off, hypocotyl rots, root rots, crown rots, vascular wilts, and necrotic ring spot.

As such, research and developmental efforts continue in the treatment of pests and diseases affecting agriculture and horticulture.

### SUMMARY

It has been recognized that it would be advantageous to develop a composition that can treat fungal diseases affecting plants. As such, in one embodiment, an anti-fungal aqueous composition can comprise: a nitrogen source material having a total nitrogen content in an amount of about 1 wt % to about 5 wt % of the total weight of the composition, a phosphate source material having total phosphate content in an amount of about 0.5 wt % to about 1.5 wt % of the total weight of the composition, a potassium source material with a soluble potash content in an amount of about 0.5 wt % to about 1.5 wt % of the total weight of the composition, and a sulfur source material in an amount of about 0.05 wt % to about 0.2 wt % of the total weight of the composition.

In another embodiment, a method of treating fungal disease on plant roots can comprise applying an anti-fungal composition to soil covering the plant roots, where the anti-fungal composition comprises: a nitrogen source material, a phosphate source material, a potassium source material, and a sulfur source material, and where the anti-fungal composition is formulated to treat a fungal disease.

In still another embodiment, a method of preventing fungal disease and/or maintaining plants free from fungal disease can comprise applying an anti-fungal composition to soil covering the plant roots, where the anti-fungal composition comprises: a nitrogen source material, a phosphate source material, a potassium source material, and a sulfur source material, and where the anti-fungal composition is formulated to prevent a fungal disease.

Additional features and advantages of the disclosure will be apparent from the detailed description which follows, taken in conjunction with the accompanying drawings, which together illustrate, by way of example, features of the disclosure.

### BRIEF DESCRIPTION OF THE DRAWINGS

Additional features and advantages of the invention will be apparent from the detailed description which follows, taken in conjunction with the accompanying drawings, which together illustrate, by way of example, features of the invention.

FIG. 1 is a photograph of a turfgrass lawn having two necrotic ring spots; and

FIG. 2 is a photograph of the turfgrass lawn of FIG. 1 after treatment with an anti-fungal composition in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION

Reference will now be made to the exemplary embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

It is noted that, as used in this specification and the appended claims, the singular forms “a,” “an,” and “the” include plural referents unless the context clearly dictates otherwise. Thus, for example, reference to “a nitrogen source material” includes one or more of such materials, reference to “a metal” includes reference to one or more of such metals, and reference to the step of “applying a solution” includes reference to one or more of such steps.

In describing and claiming the teachings of the present disclosure, the following terminology will be used in accordance with the definitions set forth below.

As used herein, “soluble potash” refers to various mined and manufactured salts that contain potassium in water-soluble form and is numerically expressed as a potassium oxide equivalent.

As used herein, “nitrogen source material” refers to materials having compounds that contain nitrogen included therein.

As used herein, “phosphate source material” refers to materials having compounds that contain phosphate included therein.

As used herein, “potassium source material” refers to materials having compounds that contain potassium included therein.

As used herein, “sulfur source material” refers to materials having compounds that contain sulfur included therein.

As used herein, “turfgrass” includes any type or variety of grass including graminoids.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 10 to about 50” should be interpreted to include not only the explicitly recited values of about 10 to about 50, but also include individual values and sub-ranges within the indicated range. Thus, included in this numerical range are individual values such as 20, 30, and 40 and sub-ranges such as from 10-30, from 20-40, and from 30-50, etc. This same principle applies to ranges reciting only one numerical value. Furthermore, such an interpretation should apply regardless of the breadth of the range or the characteristics being described.

The present disclosure relates to compositions and methods that can treat fungal diseases that affect plants. Specifically, the present disclosure is drawn to treatment of fungal diseases in plants without the use of traditional fungicides. As such, in one embodiment, an anti-fungal composition can comprise: a nitrogen source material, a phosphate source material, a potassium source material, and a sulfur source material. The composition can effectively treat fungal diseases upon application to a plant. In one aspect, the application can be to the roots of the plant, directly or via treatment to the soil of the plant.

Generally, for an aqueous composition, the nitrogen source material can have a total nitrogen content in an amount of about 0.1 wt % to about 0.5 wt % based on the total weight of the composition. In one aspect, the amount of total nitrogen can be from about 015 wt % to about 0.45 wt %, or even about 0.25 wt % to about 0.35 wt %. The total nitrogen content can include nitrogen compounds selected from the group consisting of ammonical nitrogen, nitrate nitrogen, urea, and mixtures thereof. In one aspect, the total nitrogen content comprises a mixture of ammonical nitrogen, nitrate nitrogen, and urea. As such, in one embodiment, the ammonical nitrogen can comprise about 5 wt % to about 10 wt % of the total nitrogen content, the nitrate nitrogen comprises about 5 wt % to about 10 wt % of the total nitrogen content, and the urea comprises about 80 wt % to about 90 wt % of the total nitrogen content. In one aspect, the mixture can have ammonical nitrogen, nitrate nitrogen, and urea in a 1:1:13 ratio, respectively, by weight.

Generally, for an aqueous composition, the phosphate source material can have a total phosphate content in an amount of about 0.05 wt % to about 0.15 wt % based on the total weight of the composition. In one aspect, the amount of total phosphate can be from about 0.075 wt % to about 0.125 wt %. Further, the potassium source material can have a total potassium content in an amount of about 0.05 wt % to about 0.15 wt % based on the total weight of the composition. The amount of total potassium can be from about 0.075 wt % to about 0.125 wt %. In one embodiment, the potassium source material can comprise soluble potash.

Generally, for an aqueous composition, the sulfur source material can have a total sulfur content present in an amount of about 0.005 wt % to about 0.02 wt % based on the total weight of the composition. In one aspect, the amount of sulfur can be from about 0.01 wt % to about 0.015 wt %.

Additionally, the anti-fungal composition can further comprise a metal. In one embodiment, the metal can be selected from the group consisting of: copper, iron, manganese, zinc, and mixtures thereof. Generally, for the aqueous composition, the metal can be present in an amount of about 0.002 wt % to about 0.01 wt % based on the total weight of the composition. In one aspect, the amount of metal can be from about 0.004 wt % to about 0.008 wt %.

The anti-fungal aqueous composition can have varying concentrations of total nitrogen, total phosphate, total potassium, soluble potash, and total sulfur. In one aspect, the concentration of the total nitrogen can be from about 0.1 M to about 0.4 M, or even, 0.125 M to about 0.375 M. In another aspect, the concentration of the total phosphate can be from about 0.005 M to about 0.02 M, or even, 0.0075 M to about 0.0125 M. In still another aspect, the concentration of the potassium can be from about 0.005 M to about 0.02 M expressed as potassium oxide equivalent, or even, 0.0075 M to about 0.0125 M. In yet another aspect, the concentration of the sulfur can be from about 0.001 to about 0.005 M, or even, about 0.002 M to about 0.004 M.

Generally, the anti-fungal compositions described herein can be used to treat fungal diseases of plants. In one embodiment, a method of treating fungal disease on plant roots can comprise applying an anti-fungal composition to soil covering the plant roots. Alternatively, in one embodiment, the application can be directly to the plant roots. As discussed herein, the anti-fungal composition can generally comprise a nitrogen source material, a phosphate source material, a potassium source material, and a sulfur source material, where the anti-fungal composition is formulated to treat a fungal disease.

In one embodiment, the anti-fungal composition can be a solid composition having 25 wt % to 30 wt % of the nitrogen source material, 5 wt % to 10 wt % of the phosphate source material, 5 wt % to 15 wt % of the potassium source material, and 0.5 wt % to 1.5 wt % of the sulfur source material. In one aspect, the anti-fungal composition can be applied to the soil in an amount of about 1 to 4 tablespoons per square foot of soil. In one specific aspect, the anti-fungal composition can be applied to the soil in an amount of about 4 tablespoons per square foot of soil.

In another embodiment, the anti-fungal composition can be an aqueous composition having about 0. 1 wt % to about 0.5 wt % of the nitrogen source material, about 0.05 wt % to about 0.15 wt % of phosphate source material, about 0.05 wt % to about 0.15 wt % of the potassium source material, and about 0.005 wt % to about 0.02 wt % of the sulfur source material.

In one aspect, the amount of anti-fungal aqueous composition used to treat the plant(s) can be from about 0.5 gallon per square foot to about 2 gallon per square foot of the plant(s) to be treated. In another aspect, the amount can be about 1 gallon per square foot.

The treatments can further comprise applying water to the soil of the plant(s) in an amount of about 1 gallon per square foot. The additional application of water can be applied at least once a day to about once every three days for a period from about 1 week to about 4 weeks. In one aspect, the water can be applied every other day during the period. Additionally, in one embodiment, before applying the anti-fungal compositions, the soil of the plant can be aerated.

While the present methods and compositions can generally be used for any plants suffering from fungal diseases, in one embodiment, the plant can be a turfgrass. Additionally, the fungal disease can include fungal species selected from the group consisting of: Fusarium, Pythium, Phytophthora, Verticillium, Rhizoctonia, Macrophomina, Thielaviopsis, Ophiosphaerella, and Scierotinas. In one aspect, the fungal disease can be necrotic ring spot, Ophiosphaerella korrae. Notably, contrary to certain anti-fungal compositions, the present anti-fungal compositions can be applied at any time of the year to treat the fungal disease including, for example, necrotic ring spot. In one aspect, the anti-fungal compositions can be applied in the spring. In another aspect, the anti-fungal compositions can be applied in the summer, including in one specific aspect, July and/or August. In still another aspect, the anti-fungal composition can be applied in the fall.

In addition to the above, a method of preventing fungal disease and/or maintaining plants free from fungal disease can comprise applying the anti-fungal compositions disclosed herein to the soil covering the plant roots or directly to the plant roots. Notably, after the treatment provided herein, the anti-fungal compositions can further be used as a preventative for fungal disease. Additionally, the anti-fungal compositions can be used to maintain the plants free from fungal disease once treated or before fungal disease has infected the plants. Such compositions can include those previously described as well as compositions diluted down to about half to a tenth of such strength as previously described. Such dilution can be in the amount applied to the plants or the concentration of the components.

For example, in one embodiment, the anti-fungal composition can be a solid composition having 25 wt % to 30 wt % of the nitrogen source material, 5 wt % to 10 wt % of the phosphate source material, 5 wt % to 15 wt % of the potassium source material, and 0.5 wt % to 1.5 wt % of the sulfur source material; where the anti-fungal composition is applied to the soil in an amount of about 1 tablespoon per square foot of soil.

In another embodiment, the anti-fungal composition can be an aqueous composition having about 0.025 wt % to about 0.125 wt % of the nitrogen source material, about 0.0125 wt % to about 0.0375 wt % of phosphate source material, about 0.0125 wt % to about 0.0375 wt % of the potassium source material, and about 0.00125 wt % to about 0.005 wt % of the sulfur source material; and wherein the anti-fungal aqueous composition is applied in an amount of about 1 gallon per square foot.

### EXAMPLES

The following examples illustrate embodiments of the disclosure that are presently known. Thus, these examples should not be considered as limitations of the present disclosure, but are merely in place to teach how to make the useful compositions of the present disclosure based upon current experimental data.

### Example 1

### Anti-Fungal Aqueous Composition

0.1 lbs of a water soluble acid plant food containing 30% total nitrogen, 10% available phosphate, 10% soluble potash, 1% sulfur (Water Soluble Acid Plant Food 30-10-10 available from Master Nursery®, also available as 30-10-10 from Grow More, Inc.) is admixed in about 1 gallon of water.

### Example 2

### Anti-Fungal Treatment

A necrotic ring spot covering approximately 1 square foot of grass is aerated and treated with about 1 gallon of the anti-fungal aqueous composition of Example 1. After applying the anti-fungal aqueous composition to the grass, the area is further treated with 1 gallon of water every other day for two weeks. The necrotic ring disappears over 2 to 4 weeks.

### Example 3

### Anti-Fungal Aqueous Composition

0.2 lbs of a water soluble acid plant food containing 30% total nitrogen, 10% available phosphate, 10% soluble potash, 1% sulfur (Water Soluble Acid Plant Food 30-10-10 available from Master Nursery®, also available as 30-10-10 from Grow More, Inc.) was admixed in about 2 gallons of water.

### Example 4

### Anti-Fungal Treatment

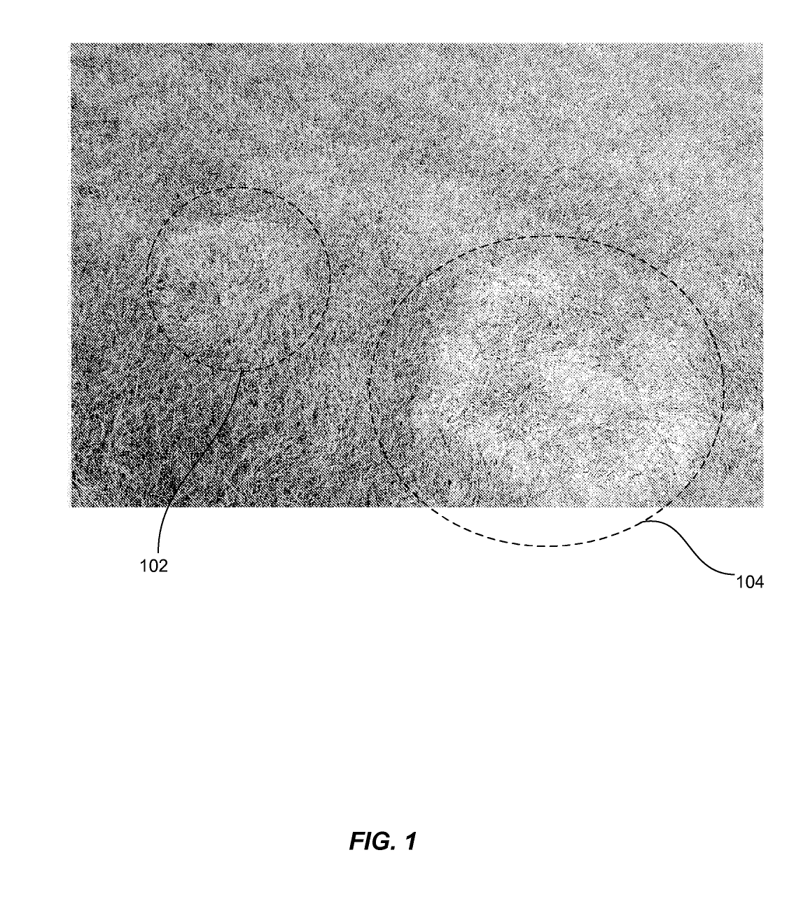

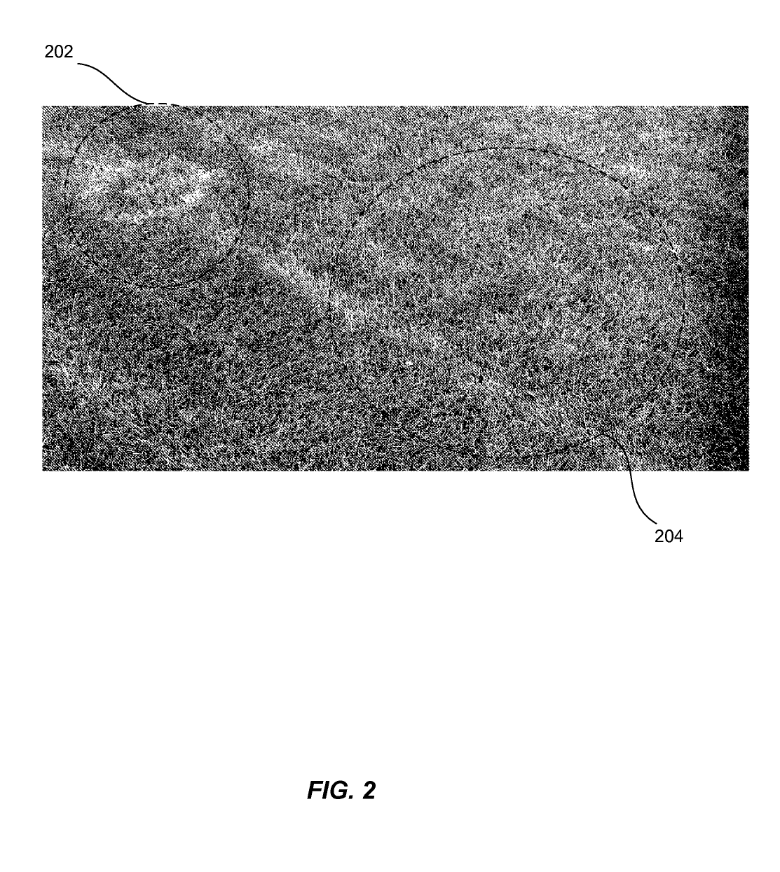

A necrotic ring spot covering approximately 1.5 ft² was treated with 1.5 gallons of the aqueous anti-fungal composition of Example 3. The composition was even dispersed over the necrotic ring spot and further treated by approximately 1 gallon of water per ft² for a period of 3 times a week over approximately 3 weeks. FIG. 1 is a photograph of 2 necrotic ring spots (upper 102 and lower 104) before treatment. The lower ring was treated as described above. FIG. 2 shows the necrotic ring spots after treatment. Notably, the treated ring 202 has completely disappeared while the untreated ring 202 remains unchanged.

It is to be understood that the above-referenced arrangements are only illustrative of the application for the principles of the present disclosure. Numerous modifications and alternative arrangements can be devised without departing from the spirit and scope of the present disclosure. While the present disclosure has been shown in the drawings and fully described above with particularity and detail in connection with what is presently deemed to be the most practical embodiment(s) of the disclosure, it will be apparent to those of ordinary skill in the art that numerous modifications can be made without departing from the principles and concepts of the disclosure as set forth herein.

What is claimed is:

1. An anti-fungal aqueous composition, comprising:
a nitrogen source material having a total nitrogen content in an amount of about 0.1 wt % to about 0.5 wt % of the total weight of the composition;
a phosphate source material having total phosphate content in an amount of about 0.05 wt % to about 0.15 wt % of the total weight of the composition;
a potassium source material with a soluble potash content in an amount of about 0.05 wt % to about 0.15 wt % of the total weight of the composition; and
a sulfur source material in an amount of about 0.005 wt % to about 0.02 wt % of the total weight of the composition.

2. The anti-fungal aqueous composition of claim 1, further comprising:
a metal in an amount of about 0.002 wt % to about 0.01 wt % of the total weight of the composition.

3. The anti-fungal aqueous composition of claim 1, wherein the total nitrogen content can include nitrogen compounds selected from the group consisting of: ammonical nitrogen, nitrate nitrogen, urea, and mixtures thereof.

4. The anti-fungal aqueous composition of claim 3, wherein the ammonical nitrogen can comprise about 5 wt % to about 10 wt % of the total nitrogen content, the nitrate nitrogen comprises about 5 wt % to about 10 wt % of the total nitrogen content, and the urea comprises about 80 wt % to about 90 wt % of the total nitrogen content.

5. The anti-fungal aqueous composition of claim 1, wherein the metal is selected from the group consisting of: copper, iron, manganese, zinc, and mixtures thereof.

6. The anti-fungal aqueous composition of claim 1, wherein the concentration of the total nitrogen is from 0.1 M to about 0.4 M, the concentration of the total phosphate is from 0.005 M to about 0.02 M; the concentration of the soluble potash is from 0.005 M to about 0.02 M; and the concentration of the sulfur is from 0.001 M to about 0.005 M.

7. A method of treating fungal disease on plant roots, comprising applying an anti-fungal composition to soil covering the plant roots, wherein the anti-fungal composition comprises:
a nitrogen source material;
a phosphate source material;
a potassium source material; and
a sulfur source material;
wherein the anti-fungal composition is formulated to treat a fungal disease.

8. The method of claim 7, wherein the anti-fungal composition further comprises a metal selected from the group consisting of: copper, iron, manganese, zinc, and mixtures thereof.

9. The method of claim 7, wherein the anti-fungal composition is a solid composition having 25 wt % to 30 wt % of the nitrogen source material, 5 wt % to 10 wt % of the phosphate source material, 5 wt % to 15 wt % of the potassium source material, and 0.5 wt % to 1.5 wt % of the sulfur source material.

10. The method of claim 8, wherein the anti-fungal composition is applied to the soil in an amount of 1 to 4 tablespoons per square foot of soil.

11. The method of claim 7, wherein the anti-fungal composition is an aqueous composition having about 0.1 wt % to about 0.5 wt % of the nitrogen source material, about 0.05 wt % to about 0.15 wt % of phosphate source material, about 0.05 wt % to about 0.15 wt % of the potassium source material, and about 0.005 wt % to about 0.02 wt % of the sulfur source material.

12. The method of claim 11, wherein the anti-fungal aqueous composition is applied in an amount of about 0.5 gallon per square foot to about 2 gallon per square foot.

13. The method of claim 7, wherein the plant is turfgrass.

14. The method of claim 7, wherein the fungal disease includes fungal species selected from the group consisting of: Fusarium, Pythium, Phytophthora, Verticillium, Rhizoctonia, Macrophomina, Thielaviopsis, Ophiosphaerella, and Scierotinas.

15. The method of claim 7, wherein the fungal disease is necrotic ring spot.

16. The method of claim 7, further comprising applying water to the soil in an amount of about 1 gallon per square foot, wherein the water is applied from about at least once per day to about once every three days.

17. The method of claim 7, further comprising aerating the soil before applying.

18. A method of preventing fungal disease and/or maintaining plants free from fungal disease, comprising applying an anti-fungal composition to soil covering the plant roots, wherein the anti-fungal composition comprises:
a nitrogen source material;
a phosphate source material;
a potassium source material; and
a sulfur source material;
wherein the anti-fungal composition is formulated to prevent a fungal disease.

19. The method of claim 18, wherein the anti-fungal composition is a solid composition having 25 wt % to 30 wt % of the nitrogen source material, 5 wt % to 10 wt % of the phosphate source material, 5 wt % to 15 wt % of the potassium source material, and 0.5 wt % to 1.5 wt % of the sulfur source material; and wherein the anti-fungal composition is applied to the soil in an amount of about 1 tablespoon per square foot of soil.

20. The method of claim 18, wherein the anti-fungal composition is an aqueous composition having about 0.025 wt % to about 0.125 wt % of the nitrogen source material, about 0.0125 wt % to about 0.0375 wt % of phosphate source material, about 0.0125 wt % to about 0.0375 wt % of the potassium source material, and about 0.00125 wt % to about 0.005 wt % of the sulfur source material; and wherein the anti-fungal aqueous composition is applied in an amount of about 1 gallon per square foot.
